(19) United States
(12) Patent Application Publication
(10) Pub. No.: US 2007/0130367 A1
(43) Pub. Date: Jun. 7, 2007

(54) Inbound connection prioritization

(76) Inventor: Vivek Kashyap, Beaverton, OR (US)

Correspondence Address: LIEBERMAN & BRANDSDORFER, LLC, 802 STILL CREEK LANE, GAITHERSBURG, MD, 20878, US

(21) Appl. No.: 11/219,983

(22) Filed: Nov. 18, 2005

(51) Int. Cl. G06F 15/16

(52) U.S. Cl. 709/245

(57) ABSTRACT

Multiple listening sockets are supported on a single local address port through use of a duplication flag. Each of the listening sockets has a logical queue. Upon creation of a listening socket, the socket is classified and assigned an identifier. As data packets are received, a manager is provided to map the data packets to one of the listening sockets based upon the assigned classification. Receipt of the data packet by an appropriately classified socket, results in the data packet being placed on the logical queue of the assigned listening socket.

### BACKGROUND OF THE INVENTION

1. Technical Field

This invention relates to the field of operating systems and computer networking. More specifically, the invention is directed to enable a server to support local prioritization of incoming connection requests.

2. Description of the Prior Art

Application server providers and web hosting services that co-host multiple customer sites on the same server cluster or large symmetric multiprocessors are becoming increasingly common in the current Internet infrastructure. The increasing growth of electronic commerce on the Internet means that any server down time that affects the clients being serviced may result in a corresponding loss of revenue. Additionally, the unpredictability of flash crowds can overwhelm a hosting server and bring down multiple customer sites simultaneously, affecting the performance of a large number of clients. Therefore, it becomes essential for hosting services to provide performance isolation, fast recovery times, and continuous operation under overload conditions to at least preferred customers or transactions.

In a system that has a server cluster hosting multiple customer sites, such sites are referred to as co-hosted. Each co-hosted customer site may have different quality of service goals based on the price of the service and the application requirements. Furthermore, each customer site may require different services during overload based on the clients identity and the content they access. When providing service differentiation during overload it is important to know who the request was from and what it is intended to do.

A protocol is a set of rules by which two or more computers communicate over a network connection. Common protocols include TCP/IP (Transmission Control Protocol/Internet Protocol), UDP (User Datagram Protocol), to name a few etc. Each protocol provides unique characteristics suitable for a particular application or data network. Internet transport protocols do not discriminate between users. Data packets of associated network connection requests, hereinafter referred to as requests, are passed between routers and switches that make up the Internet fabric based on the hardware's instantaneous view of the best path between source and destination nodes specified in the packet. Because each packet may take a different path, the latency of a packet cannot be guaranteed and, in practice, varies significantly. Accordingly, priority assigned to a data packet must be inserted by the sender, or another system in the path, and recognized by the recipient.

There are known prior art solutions for content aware service differentiation. One solution for assigning priority to a data packet is content aware service differentiation wherein an application conducts the differentiation in user space. However, there is no differentiation of user assigned priority in the kernel. Therefore, the kernel will allocate resources to the request without any differentiation among the priority assigned to the request in the user space. This results in utilizing kernel resources for low priority requests at the expense of the higher priority requests. A second solution for assigning priority to a data packet in kernel space is disclosed in U.S. Patent Publication 2003/0005122 to Freimuth et al., wherein a service differentiation technique in the kernel networking stack classifies requests, and places the requests in a queue based upon the classification. This publication enables all applications to run without knowledge, i.e. transparent, of internal prioritization being applied to a listening socket that receives the requests. A socket is a software abstraction utilized by networking applications to interface with the kernel for sending and receiving networking packets. A listening socket is a socket that is in the ‘LISTEN’ state of the communication protocol. In this LISTEN state the socket is used to receive new connection requests from clients. An application receives access to the new socket by invoking the ‘accept’ system call on the listening socket. The Freimuth et al. publication prioritizes requests in the kernel by invoking resources, such as memory, CPU priority, etc. However, in Freimuth et al., all connection requests are received by a single queue. As such, the prioritization of Freimuth et al. requires a large kernel networking stack to manage multiple requests.

There are other limitations associated with service differentiation techniques known in the prior art. For example, known techniques utilize one connection, i.e. socket, between the application and the kernel and place all connection requests in a single queue. There is no tool provided to differentiate priorities associated with different requests. A single socket receives both high priority and low priority requests. An application reading the socket does not know the priority of the request it will receive before actual receipt. Nor is the application reading the socket aware of the priority of the request received unless it does a similar classification to that already conducted by the kernel. Any workload infrastructure which may need to associate resources based on the priority is not aware of the priority of the request being handled unless the application identifies an associated classification. Accordingly, there is a need for a solution that overcomes the limitations listed above, and removes excess burden from the kernel.

### SUMMARY OF THE INVENTION

This invention comprises a method and system for creating multiple sockets and assigning requests to an appropriately classified socket based upon an associated categorization of both the socket and the request.

In one aspect, a method is provided for managing inbound connection requests. Two or more listening sockets are created on a single local address port with each created listening socket assigned a classification, and each listening socket having a single logical queue. Each inbound connection request is assigned a category. Similarly, each inbound connection request is mapped to one of the queues of one of the listening sockets based upon the categorization of the request and the assigned classification of the socket.

In another aspect of the invention, two or more listening sockets are created on a single local address port, with each listening socket having a single accept queue and each listening socket assigned a classification and a single accept queue. A category is assigned to an inbound request packet. A manager is provided to map an inbound request packet to the queue of one of the listening sockets based categorization of the packet and the assigned classification of each socket.

In yet another aspect of the invention, an article is provided with a computer-readable signal-bearing medium. Means in the medium are provided for creating at least two listening sockets on a single local address port, and for assigning a classification to each created listening socket. Each of the listening sockets has a single accept queue. Means in the medium are also provided for assigning a category to an inbound connection request. Means in the medium are also provided for mapping an inbound request to the queue of one of the listening sockets based on the category assigned to the request and classification of each of the sockets.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flow chart illustrating a process for creating multiple listening sockets according to the preferred embodiment of this invention, and is suggested for printing on the first page of the issued patent.

FIG. 2 is a flow chart for receiving an incoming request and processing the request in consideration of multiple listening sockets.

FIG. 3 is a block diagram illustrating elements utilized for classification of a incoming connection request and forwarding the connection request to an appropriate listening socket.

FIG. 4 is a block diagram of a tool for creating and managing multiple listening sockets.

FIG. 5 is a block diagram of a tool embedded in a computer readable medium for creating and managing multiple listening sockets.

### DESCRIPTION OF THE PREFERRED EMBODIMENT

### Overview

Inbound connection requests to a server are categorized and processed based upon a priority associated with the categorization. Multiple listening sockets are created on a server to receive inbound connection requests. Each of the listening sockets is assigned a classification identifier for receipt of an inbound connection request. Upon receipt of a new connection request by the server, the request is queued to the appropriately classified listening socket.

### Technical Details

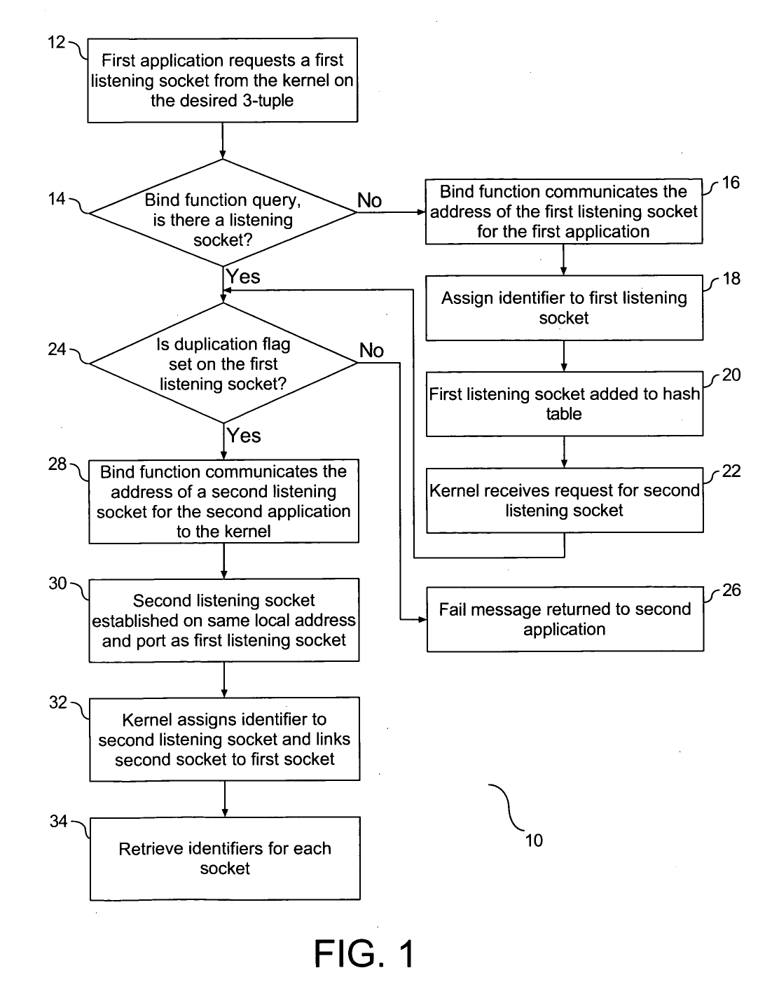

FIG. 1 is a flow chart (10) illustrating how the kernel may be enhanced to support two or more listening sockets on the same local address port. A first application requests a first listening socket, also known as the original listening socket, from the kernel on a desired 3-tuple (12). A listening socket is associated with a combination of a communication protocol, an address, and a port on which the requests are received. In TCP/IP and UDP networks, a port is an endpoint to a logical connection. This combination of the communication protocol, address, and port are hereinafter referred to as a listening 3-tuple. The process of association of the 3-tuple to a socket is called ‘binding’. Upon completion of the association of the 3-tuple to the socket, the socket is referred to as ‘bound’ to the 3-tuple. In response to the first application's bind request, a test is conducted to determine if there is already a listening socket on the desired 3-tuple (14). If there is no listening socket present on the desired 3-tuple, the first listening socket will be bound to the 3-tuple (16). Thereafter, an identifier is assigned by the kernel to the first listening socket (18). This identifier serves as the classification assignment for the socket. In one embodiment, the application may retrieve the value of this identifier from the kernel using a suitable system call. After the first listening socket has been established, the kernel receives a request for a second listening socket (22). Following step (22) or a positive response to the test at step (14), a test is conducted to determine if a duplication flag is set on the first listening socket (24). The duplication flag is used as an indicator to accept multiple listening sockets on the same address and port. If the response to the test at step (24) is negative, this is an indication that the duplication flag is not set, and the second application request will receive a request fail message and the request fails (26). However, a positive response to the test at step (24) is an indication that the duplication flag is set and the first socket is set to accept additional listening sockets on the same address and port. Accordingly, the duplication flag is implemented to support establishment of multiple listening sockets on the same address and port.

In response to a positive response to the test at step (24) for the second application request, the bind function is implemented to tell the kernel the application 3-tuple for the second listening socket to be created (28). A second listening socket is then established on the same local address and port as the first listening socket (30) through the bind function communicating to the kernel the application address. The kernel then assigns an identifier to the second listening socket (32) and links the second listening socket to the first listening socket. In one embodiment, the first and second sockets may be linked by a linked list or a hash table, wherein the original listening socket forwards a data packet associated with a request to the second listening socket linked to the original listening socket. Similarly, the hash table may list the location of each listening socket, and a hash table look-up may enable a data packet to be directly forwarded to an appropriately classified listening socket. The assignment of identifiers to each of the listening sockets, also known as a listen identifier, distinguishes multiple sockets on the same local address and port. The identifiers may be retrieved by the calling application. The identifier for each one of the created listening sockets on the same local address and communication port can be retrieved using an I/O control, such as an operating system call. In one embodiment, the listen identifier may be a running number with the first socket being assigned a value of zero. Once the listen identifiers have been set for each listening socket, the listening sockets enter a listen state to accept and process incoming connections and associated data packets (34). Although FIG. 1 shows creation of two sockets on a single address and communication port, the process may be expanded for creation of additional listening sockets, and is not limited to the two shown herein.

Accordingly, the establishment of the duplication flag enables the kernel to create multiple listening sockets on the same address and communication port.

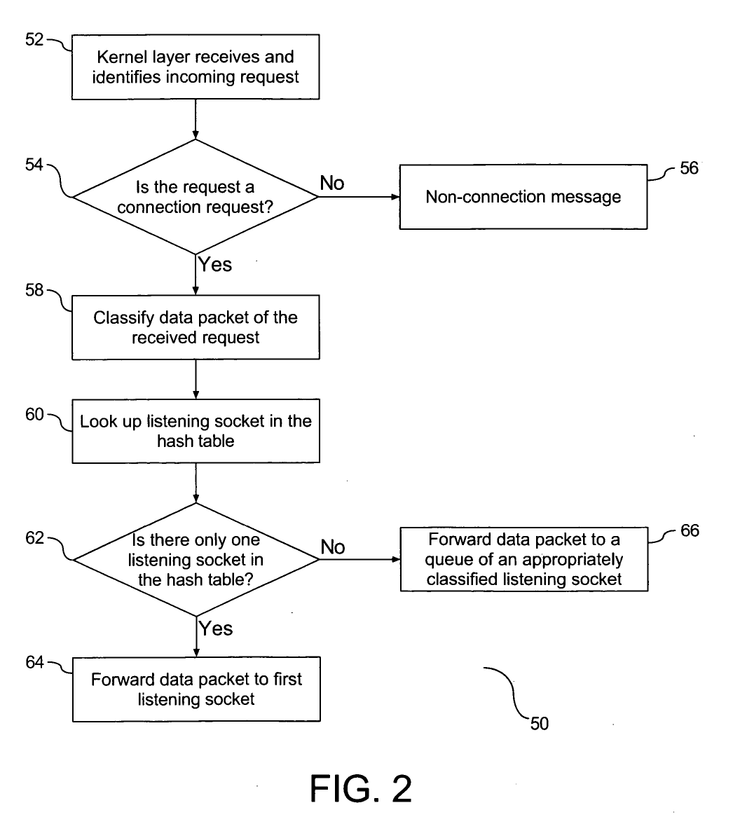

FIG. 2 is a flow chart (50) illustrating details of a process for receiving an incoming request and servicing the request following creation and establishment of multiple listening sockets on the same address and port. An incoming request is received and identified by the kernel layer (52). A test is then conducted to determine if the received request is a connection request (54). A non-connection message will go directly to a connected socket or other socket associated with the packet (56). However, a positive response to the test at step (54) will result in classification of a data packet of the received request based upon selection criteria defined in classification rules of the established listening sockets (58). In TCP/IP, a syn classifier is used in the kernel to classify incoming TCP connections into their service classes before TCP protocol processing. Following classification, the request is placed in a first logical queue for protocol processing. Once protocol processing for the incoming packet is complete at step (58), a listening socket is looked up (60). Thereafter, a test is conducted to determine if there is only one listening socket (62). If the response to the test at step (62) is positive, the data packet of the request is forwarded to the sole listening socket. However, if the response to the test at step (62) is negative, the data packet of the request is placed in a second logical queue, also known as an accept queue, of an appropriately classified listening socket (66) from where it is forwarded to an associated listening socket. A classification is assigned to each created socket, and each inbound connection request is mapped to one of the second logical queues of one of the listening sockets based on the assigned classification. The requests received on the socket may be categorized to different sockets based on the content of the incoming request. In one embodiment, the classification rules could be based on criteria such as the sender of the request as determined from the sender's IP address, content of the TCP, or content of an upper layer protocol, such as HTTP content. Each listening socket has a single logical queue associated therewith. A resource manager may assign static resources, such as CPU, memory, priority, etc., to threads of execution that read from each of the listening sockets based upon the classification of the socket. Thereby, all work done as a result of requests received on a particular socket may be given less or more resources based on its categorization. Following placement of the received data packet in the second logical queue, the server may continue processing other transactions. Accordingly, received requests are placed in a queue of a corresponding socket based upon classification of the request and a corresponding classification of the socket

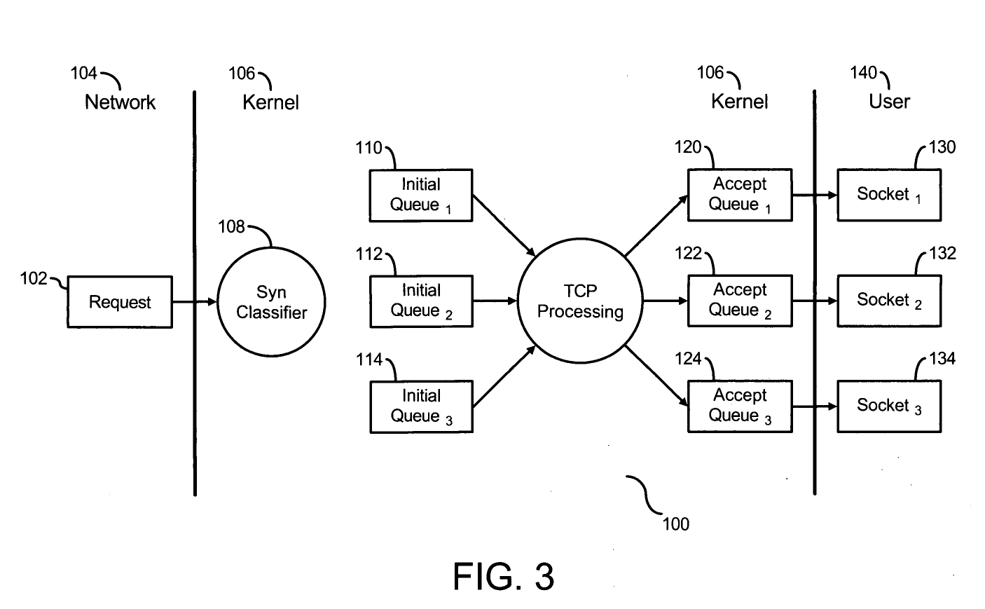

FIG. 3 is a block diagram (100) illustrating elements utilized for classification of a connection request and forwarding the connection request to an appropriate socket. The elements shown herein are demonstrative of a TCP/IP messaging protocol. Although FIG. 2 shows TCP/IP as the messaging protocol for a connection request, other messaging protocols may be implemented, such as SCTP (Simple Control Transport Protocol), and any connection oriented protocol. Accordingly, implementation of the invention is not limited to the TCP/IP messaging protocol shown herein. As shown, a request (102) is received across the network (104) by a syn classifier (108) in the kernel networking stack (106). The syn classifier (108) processes the initial connection request upon receipt. This processing generally includes determining the identity of the sender, classifying the initial connection request, and matching the request to a rule. Following the initial classification process, the initial connection request is placed in one of three first logical queues (110), (112), and (114). Once the initial connection request is in one of the first logical queues (110), (112), and (114) it proceeds to TCP processing (116), where the request is again classified. Following TCP protocol processing, connection at the protocol level is set up, and the request is placed in one of three second logical queues (120), (122), and (124). The second logical queues (120), (122), and (124) are in the kernel networking stack (106) that proceed directly into one of three appropriately classified listening sockets (130), (132), and (134) in the user layer (140). The quantity of queues and listening sockets are merely an illustrative quantity. The system may be enlarged to include additional queues and sockets, and similarly, the system may be reduced to include fewer queues and sockets.

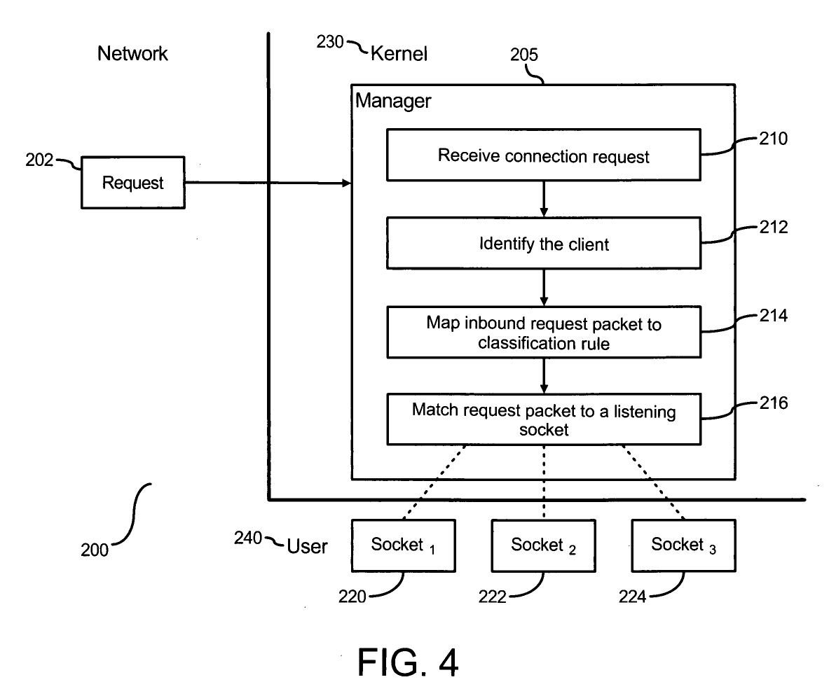

The process for creating and using multiple listening sockets on a single address and communication port may be in the form of a manager. FIG. 4 is a block diagram (200) illustrating the manager (205) in the kernel networking stack (230) in communication with multiple listening sockets (220), (222), and (224) in the user layer (240). As shown, the manager (205) is located in the kernel networking stack (230) and receives (210) the connection request (202). Upon receipt of the request, the manager (205), identifies the client sending the request (212) and maps the an inbound request packet associated with the request to a classification rule (214). Following the mapping process at (214), the manager matches the request packet with one of the listening sockets (216). The process of matching the request packet to a socket includes placing the packet in a logical queue assigned to the socket. Additionally, the manager is responsible for assigning the classification to the sockets and to update rules for the kernel to associate incoming connection requests to the classified sockets.

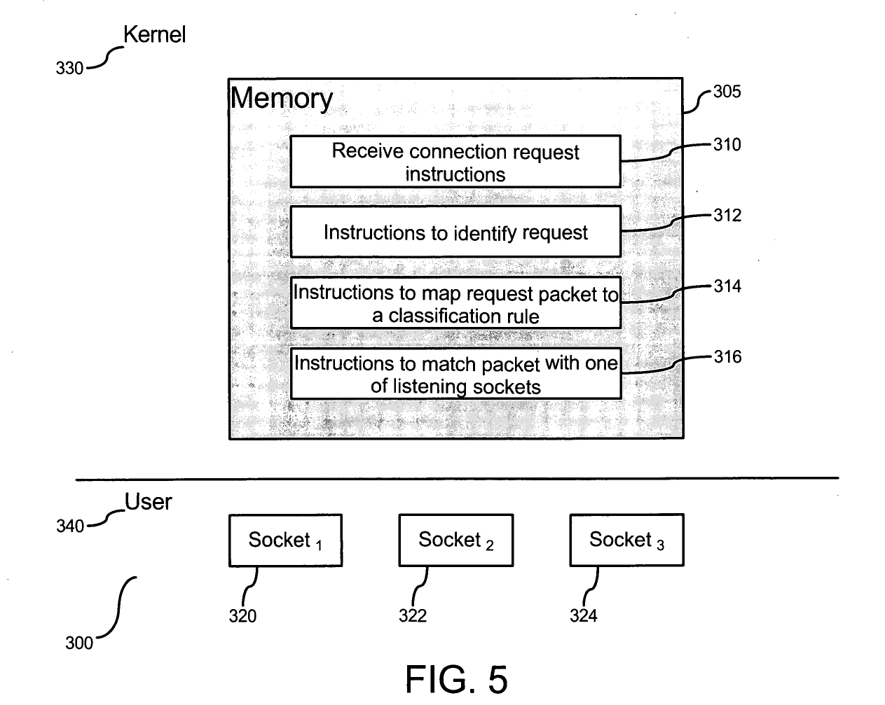

In one embodiment, the invention is implemented in software, which includes but is not limited to firmware, resident software, microcode, etc. The software implementation can take the form of a computer program product accessible from a computer-useable or computer-readable medium providing program code for use by or in connection with a computer or any instruction execution system. FIG. 5 is a block diagram (300) illustrating the elements of the manager stored in memory (305) in the kernel networking stack (330) with multiple listening sockets (320), (322), and (324) in the user layer (340). Instructions for a connection request (312) are received in memory (305) of the kernel networking stack (330). Following receipt in memory (305), instructions are provided to identify the request packet (312), map the request packet associated with the request to a classification rule (314), and match the request packet (316) with one of the listening sockets (320), (322), or (324) in the user layer (340). Additionally, instructions in memory are provided for assigning classification to the sockets and to update rules for the kernel to associate incoming connection requests to the classified sockets.

The quantity of queues and listening sockets illustrated in FIGS. 4 and 5 are merely an illustrative quantity. The systems may be enlarged to include additional queues and sockets, and similarly, the systems may be reduced to include fewer queues and sockets. Accordingly, the manager may be in the form of hardware elements in the computer system, or software elements in a computer-readable format or a combination of software and hardware elements.

### Advantages Over the Prior Art

Multiple listening sockets are created on a single address and port. Receipt of an inbound request causes a hash table or linked list look-up to map the request to one of the listening sockets. The hash table or linked list communicates the location of the original listening socket or all of the listening sockets. The inbound request is forwarded to the location of an appropriately classified listening socket. Regardless of the narrow or expanded list of the hash table, multiple listening sockets are provided with each socket having a single accept queue. Priorities are assigned to each of the multiple sockets, and the received packet is queued to the socket corresponding to the classification of the packet instead of queuing the received packet to an original listening socket. Resources may be appropriately allocated to the respective sockets corresponding to the designated priorities.

### Alternative Embodiments

It will be appreciated that, although specific embodiments of the invention have been described herein for purposes of illustration, various modifications may be made without departing from the spirit and scope of the invention. In particular, the second and all subsequent listening sockets may be added to the hash list as an independent entry. Upon receipt of a data packet, the hash table is consulted and the packet is forwarded to a queue of an appropriately classified socket. Accordingly, the scope of protection of this invention is limited only by the following claims and their equivalents.

We claim:

1. A method for managing inbound connection requests comprising:
creating at least two listening sockets on a single local address port and assigning a classification to each created listening socket, with each listening socket having a single logical queue;
categorizing a received inbound connection request; and
mapping said inbound request to said queue of one of said listening sockets based on said categorization of said request and said assigned classification of said sockets.

2. The method of claim 1, wherein the step of mapping an inbound request to said queue includes allowing static resource allocation categorization.

3. The method of claim 1, wherein the step of creating at least two listening sockets on a single local address port includes setting a flag on a first socket to support creation of multiple sockets on a single local address port.

4. The method of claim 1, wherein the step of creating at least two listening sockets on a single address port includes placing only an identifier of a first listening socket in a hash table and linking each secondary listening socket to said first listening socket.

5. The method of claim 1, wherein the step of creating at least two listening sockets on a single address port includes placing identifiers of each of said listening sockets in a hash table.

6. The method of claim 1, wherein the step of mapping an inbound request to said queue of one of said listening sockets includes assigning a classification of said inbound request based upon content of said request.

7. A computer system comprising:
at least two listening sockets on a single local address port, with each listening socket having an assigned classification and a single accept queue;
a category assigned to an inbound request packet; and
a manager adapted to map said inbound request packet to said queue of one of said listening sockets based on said assigned category of said packet and said assigned classification of each socket.

8. The system of claim 7, wherein said manager provides static resource allocation categorization.

9. The system of claim 7, wherein said listening sockets on said local address port includes a flag set on a first socket to support creation of multiple sockets.

10. The system of claim 7, further comprising a hash list adapted to store an identifier of each created socket.

11. The system of claim 7, wherein said manager is adapted to identify an inbound request prior to placement of said request in said queue.

12. The system of claim 11, further comprising said manager adapted to match said identified inbound request with said classification.

13. An article comprising:
a computer-readable signal-bearing medium;
means in the medium for creating at least two listening sockets on a single local address port and for assigning a classification to each created listening socket, with each listening socket having a single accept queue;
means in the medium for assigning a category to an inbound request packet; and
means in the medium for mapping an inbound request to said queue of one of said listening sockets based on said assigned category of said inbound request packet and said assigned classification of each listening socket.

14. The article of claim 13, wherein said means for mapping an inbound request to said queue includes allowing static resource allocation categorization.

15. The article of claim 13, wherein said means for creating at least listening sockets on a single local address port includes setting a flag on a first socket to support multiple sockets.

16. The article of claim 13, wherein said means for creating at least two listening sockets on a single address port includes adding each socket identifier to a hash list.

17. The article of claim 13, wherein said means for mapping an inbound request to said queue of said listening sockets includes identifying said inbound request.

18. The article of claim 17, further comprising means in the medium for matching said identified inbound request with said classification.
